(19) United States
(12) Patent Application Publication
(10) Pub. No.: US 2002/0003625 A1
(43) Pub. Date: Jan. 10, 2002

(54) AXIAL PATTERN ANALYSIS AND SORTING INSTRUMENT FOR MULTICELLULAR ORGANISMS EMPLOYING IMPROVED LIGHT SCATTER TRIGGER

(76) Inventors: W PETER HANSEN, CANAAN, NY (US); RUSSEL J GERSHMAN, SOMERVILLE, MA (US); PETRA B KRAULEDAT, CANAAN, NY (US)

Correspondence Address: STEFAN J. KIRCHANSKI, CROSBY, HEAFEY, ROACH & MAY, 1901 AVENUE OF THE STARS, SUITE 700, LOS ANGELES, CA, 90067, US

(21) Appl. No.: 09/465,215

(22) Filed: Dec. 15, 1999

Related U.S. Application Data
(60) Provisional application No. 60/112,280, filed on Dec. 15, 1998.

(51) Int. Cl. G01N 21/00

(52) U.S. Cl. 356/338

(57) ABSTRACT

An improved instrument that consists of an optical analyzer and a fluid switch using light scatter and fluorescence means to optically identify and activate fluidic sorting of multicellular organisms from live populations of organisms such as various life cycle stages of Caenorhabditis elegans, the larval stages of Drosophila melanogaster, and the embryonic stages of Danio rero. In the case where fluorescence from these organisms is very weak, comparatively high levels of electronic noise accompany the electronic signals that are generated by the fluorescence detector and its associated circuitry. Because these weak signals cannot be used to mark the presence of an organism, another, less noisy, signal must be used to gate fluorescence detection. A gate derived from the low-noise light scatter signal from the organism collected over an acceptance angle of at least 20 degrees. Such a light scatter signal unambiguously gates even weak fluorescence signals. These signals can then be correlated with position along the major axis of elongate, multicellular organisms and used as enhanced analysis and sorting parameters.

The present application is based on and claims priority from U.S. Provisional Application No. 60/112,280, filed Dec. 15,1998 which is incorporated herein by reference.

### BACKGROUND OF THE INVENTION

1. Field of the Invention

The present application concerns instruments to analyze and separate objects suspended in a fluid-specifically such instruments optimized to analyze and separate elongated multicellular organisms.

2. Description of Related Art

The present invention pertains to high-speed mechanisms for automatically identifying and physically selecting multicellular organisms with certain spatially distinct, optically detectable, phenotypic characteristics from mixed populations. Examples of applicable multicellular organisms are all stages of Caenorhabditis elegans, Drosophila melanogaster (fruit fly) larvae, or Danio rero (zebrafish) embryos. These are useful as model organisms for human disease and functional genomics studies. Examples of spatially distinct, optical characteristics are; the localized expression of DNA encoded fluorescent protein molecules, localized variations of the index of refraction or granularity, or localized variations in specific binding sites (receptors) for optically labeled antibodies, lectins, or other specific ligands.

Intact multicellular organisms, such as C. elegans, D. melanogaster larvae, or D. rero embryos are frequently used as model systems to help understand the function of human genes that have been implicated in disease. Human gene homologues have been identified in these model organisms and mutations have been induced specifically in those gene homologues. Such mutations frequently result in an easily observable phenotypic change in the model organism and it has been shown that certain mutants respond to pharmacological compounds and these responses collaterally produce optically detectable changes in the organism.

Mutants of intact organisms are now used as a new class of in vivo drug screens for libraries of potential pharmacological compound produced through use of combinatorial chemical methods. With these organisms, one can identify targets for drug intervention without the need to completely understand complex biochemical pathways that relate the genome to the phenotype. This allows rapid and economical screenings of the compound libraries for new and useful human drugs while limiting politically controversial testing on mammals.

The exposure of model organism mutants to diverse drug compound libraries, even when the specific mutations involved have not yet been linked to human gene homologues also helps define gene function. The addition of such functional genomic techniques to the repertoire of molecular biology and biochemistry methods can greatly accelerate the drug discovery process. Investigators can annotate drug libraries for toxicity, non-specific activity, or cell membrane permeability by observing their behavior in intact organisms. This way, toxic or ineffective libraries and/or library members can be discarded at an early stage without wasting valuable resources.

While model organisms such as the nematode C. elegans, the fruit fly D. melanogaster, and the zebrafish D. rero have been proven useful in the study of human disease, they have not yet been successfully used in the field of high speed, high throughput drug discovery. Until now high-speed preparation and analysis techniques have been missing for these large organisms. This presents a roadblock to investigators that need to search through thousands of multicellular organisms for a new mutation or for response to a given sample drug. For example, with today's molecular biology techniques, a large laboratory can produce deletion mutations in a multicellular test organism at a rate of 20 to 30 per month. Then, in order to evaluate the effect of a chemical compound library (that frequently contains 100,000 discrete compounds) on a class of mutated organisms, one must first manipulate and deposit a precise number of organisms of the mutant strain and the same development stage into various containers such as wells of a microtiter plate array. Wild type or deviants from the desired mutant strain, or organisms at a different development stage must be eliminated. Using slow, manual methods, the selection and deposition of organisms of the proper type is a bottleneck in time to the entire process of drug discovery. Additionally, manual methods rely on pipettes that dispense accurate volumes of fluid but not accurate numbers of organisms. In many studies where reproduction rate is altered by the mutation, it is necessary to begin the study of the effect of a compound from the combinatorial library with an exact, and known number of multicellular organisms in each well. This is, at best, a daunting requirement.

In addition to the need for rapid preparative methods there is a need for rapid analysis methods. For example, if a mutant strain or expression system can be characterized by a spatial pattern of fluorescence or staining, then the effect of therapeutic compounds or toxic environments on these strains might be determined by changes in these patterns. For example, green fluorescent protein (GFP) is used as reporter gene to indicate that an inserted gene has been expressed. The expression of the fluorescent protein usually occurs in a specific spatial pattern within a multicellular organism. Discrimination of one pattern from another is currently carried out manually with the fluorescent microscope. This is an extremely tedious task requiring a significant number of workers that are trained at very high academic levels.

Co-pending U.S. patent application Ser. No. 09/378,634, filed Aug. 20, 1999(which is incorporated herein by reference) describes an instrumentation system for the rapid analysis and sorting of multicellular organisms using optical characteristics such as light scatter and fluorescence to classify each organism in a flowing stream. A single value of fluorescence intensity at a given emission wavelength is detected and assigned to each organism. The present invention is an improvement that enables a flow analyzer and sorter to localize and report not only the intensity but also the position of fluorescence along the major (long) axis of the organism and use this new spatial information to sort the organisms.

If a mutant strain or transgenic organism is characterized by a stable, spatial pattern of fluorescence, staining or other optically detectable characteristics, then the effect of therapeutic compounds or toxic environments on these strains can potentially be determined by monitoring changes in these spatial patterns. Discrimination of one pattern from another is currently carried out manually with the fluorescent microscope. This is an extremely tedious task requiring a significant number of workers that are trained at very high academic levels. Automating the detection of spatial patterns of fluorescence will improve the objectivity and the speed of measurement.

Flow instruments have been used before to count the number of nematodes in a fluid volume. Such a device was described by Byerly et al (L. Byerly, R. C. Cassada, and R. L. Russell, “Machine for Rapidly Counting and Measuring the Size of Small Nematodes”, Rev. Sci. Instrum. Vol. 46, No. 5, May 1975) where the flow cytometer employed sheath flow to orient the nematodes along the direction of flow so that their size could be measured and organism-by-organism counts could be made by an electrical impedance method. The device was similar to a commercial Coulter counter. The present invention differs from the Byerly device in that it can provide a device that selects and deposits (sorts) specific organisms. The present invention is also not limited to using an impedance sensor, which can only estimate overall size, but instead uses optical sensing to spatially resolve localized features along the major axis of the organism and use these to analyze and sort.

An optical flow instrument for analyzing elongate organisms such as plankton with widths of 500 μm and lengths over 1000 μm has been described with sheath flow to achieve orientation of the plankton. (J. C. Peeters, G. B. Dubelaar, J. Ringelberg, and J. W. Visser, “Optical Plankton Analyser: a Flow Cytometer for Plankton Analysis, I: Design Considerations” Cytometry 1989 Sep. 10 (5): 522-528; and G. B. Dubelaar, A. C. Groenwegen, W. Stokdijk, G. J. van den Engh, and J. W. Visser, “Optical Plankton Analyser: a Flow Cytometer for Plankton Analysis, II: Specifications”, Cytometry 1989 Sep. 10 (5): 529-539). The size range of the plankton used in these optical flow cytometers is similar to that encountered with C. elegans nematodes, fruit fly larvae, and zebrafish embryos; however there is no provision that avoids the ambiguous light scatter signals that are eliminated by the present invention.

### SUMMARY OF THE INVENTION

The present invention uses a fluid flow stream to orient elongate, multicellular, organisms and a narrowly focused, stationary, optical beam to scan them along their major axis as they flow. Features such as cell density, refractility, granularity, and fluorescence can be detected and recorded as a function of position along the length of the oriented organism (i.e., an axial pattern scan). The invention is an improvement in speed and statistical precision over current manual techniques for analyzing multicellular organisms one by one under the microscope. The information from the scan can be used to characterize gene expression and enable physical selection and deposition of phenotypes with desired characteristics, or it can be used to determine alterations in gene expression caused by toxic or therapeutic compounds.

In the case where fluorescence from these organisms is very weak, comparatively high levels of electronic noise accompany the electronic signals that are generated by the fluorescence detector and its associated circuitry. These weak signals cannot be used to mark the presence of an organism, and another, less noisy, signal must be used to gate fluorescence detection. Axial light loss might be used as such a gate. Another preferred gate can be derived from the low-noise light scatter signal from the organism. Conventional light scatter gating, such as is practiced in flow cytometry of single cells, creates ambiguous signals when used on multicellular organisms and thus leads to false gating of fluorescence. A light scatter detection means is herein described which unambiguously gates these fluorescence signals. These signals can then be correlated with position along the major axis of elongate, multicellular organisms and used as enhanced analysis and sorting parameters.

Traditional optical flow cytometers analyze and sort small particles and single cells in liquid suspension by detecting light scatter within (over) narrow cone or solid angles at various angles to the incident optical beam and fluorescence emission at various wavelengths. Information about cell size and structure can be derived from light scatter collected at different angles. For example, information about size can be derived from light scatter detected at low angles relative to the incident optical beam while information about internal cellular granularity can be derived from light scatter detected at a wide angle (near a right angle) relative to the optical beam. Further, the prior art shows that size of the granular structures to be detected determines the angle and acceptance cone for optimal wide angle detection.

Light scatter signals collected at specific angles and over narrow cone angles are also used to gate detectors of weak fluorescence from single cells. Weak fluorescence signals cannot be effectively used to mark the presence of a cell in the optical beam because high levels of electronic noise accompany these signals. Noise spikes frequently exceed the threshold level for fluorescence detection and produce false readings that are confused as weakly fluorescing cells. To avoid this, flow cytometers generally use signals from one or more detectors situated to detect light scatter at one or more angles relative to the beam to produce relatively noise free signals that can effectively discriminate against false fluorescence from electronic noise, and gate true fluorescence from cells (The reader attention is drawn to U.S. Pat. No. 4,284,412).

It is key to the use of these light scatter detectors as fluorescence gates that their solid angle of detection be narrow. For example, so-called “low angle forward scatter” (LAFS) detectors are frequently placed as close as 0.5 degrees to the optical axis and collect light only within a one degree cone. Wide-angle light scatter detectors are frequently placed at positions ranging from approximately 10 degrees to 90 degrees off axis and also collect light within small cone angles of less than five degrees. If the cone angle of collection is not kept as small as possible, then information about granularity and size can become merged. Under these conditions for example, large cells become indistinguishable from small cells and granular cells become indistinguishable from non-granular cells of the same size.

When narrow acceptance cone light scatter (NACLS) detectors are used to monitor the passage of multicellular organism such as C. elegans, three problems arise that do not occur with single cells such as blood cells. First, it is found that the light scatter signal does not necessarily rise above baseline (zero) at the beginning of the passage of the organism through the optical beam, but instead rises at an unpredictably later time. Second, it is found that the light scatter signal does not necessarily return to baseline (zero) at the end of the passage of the organism through the optical beam, but instead returns at an unpredictably early time. Third, it is also found that the light scatter signal frequently returns to baseline (zero) at one or more unpredictable times while the organism is in the beam.

Therefore, the most basic effort to size multicellular organisms based on their “time of flight” through the analysis light beam is thwarted by this unpredictable behavior of light scatter signals that are collected over narrow cone angles. Furthermore, the narrow cone angle light scatter signals that start late are not useful for gating weak fluorescence signals. Finally, the narrow cone angle light scatter signals that return to baseline early cannot be used to denote the position of weak fluorescence along the axis of the worm. The signals that return to baseline early can also be confused with the passage of two or more separate organisms when actually only one passed through the analysis beam.

The present invention does not employ the usual single cell, light scatter detection methods, and instead uses light scatter collection over very wide cone angles when analyzing and sorting multicellular organisms. One aspect of the invention is to collect scattered light over a wide cone angle such as 20 degrees or more. This provides a light scatter signal that becomes positive accurately at the time the organism enters the beam, remains unambiguously above baseline while the organism is in the beam, and returns to baseline accurately at the time the organism exits the beam. This aspect of the invention enables another aspect of the invention, which is to use accurate, unambiguous, light scatter signals collected over wide cone angles to mark the linear position of weak and noisy fluorescence signals along the axis of the organism. The width of the cone angle needed depends upon the type of organism.

The present invention uses the unambiguous light scatter signal from a wide acceptance angle, light scatter (WACLS) detector as a gate and a timing method for the analysis of fluorescence along the axis of the organism. The location of fluorescence along the axis of the organism is an important parameter for analysis and sorting. For example, with C. elegans, it is important in many cloning applications to separate males from hermaphrodites. This can be accomplished with a fluorescently labeled lectin (wheat germ agglutinin) that binds to the vulva of the hermaphrodite and the copulatory bursa of the male. These two structures are not easily distinguishable in brightness, but the vulva is located near the midpoint of the organism and the copulatory bursa is located in the tail. Thus, axial location of fluorescence becomes the parameter for differentially analyzing and sorting males and hermaphrodites. This is illustrated schematically in FIG. 1 where two oscilloscope traces are shown for single organisms. One trace (FIG. 1B) has a fluorescent peak near the midpoint, and the other (FIG. 1C) has a fluorescent peak at the tail.

Since there is no fluorescent signal to mark the beginning of the organism in the oscilloscope traces of FIG. 1, a means must be established to mark the beginning and end of the passage of the organism through the light beam. This is done by the use of the wide acceptance cone, light scatter (WACLS) signal. The start of this signal triggers a clock in the electronic processor that, in turn causes fluorescent data to be sampled at regular intervals in time while the wide acceptance cone, light scatter signal remains above a preset threshold level. Sampling stops when the WACLS signal drops below threshold, denoting the end of the organism.

The following is a parametric representation of a multicellular organism that can be employed through the use of a WACLS signal to gate the sampling of fluorescence along the organism's axis. Consider a WACLS detector that produces signal S1 and a timing mechanism that samples signals from all other detectors every T microseconds. Assume that there are other light scatter or light absorption detectors situated at various angular positions with respect to the analysis beam. Let the signals from these detectors be denoted by S2, S3, . . . Sn. Further assume that there are fluorescence detectors sensitive to various emission wavelengths producing signals F1, F2, F3, . . . Fn. The matrix below has columns of data for each detector and rows of data for each sampling interval.

| | S1 | S2 | S3 | . . . | Sn | F1 | F2 | F3 | . . . | Fn |
|---|---|---|---|---|---|---|---|---|---|---|
| T1 | 0 | 0 | 0 | | 0 | 0 | 0 | 0 | | 0 |
| T2 | a1 | 0 | c1 | | 0 | e2 | 0 | 0 | | 0 |
| T3 | a2 | b2 | c2 | | d3 | 0 | f3 | g3 | | 0 |
| T4 | a3 | 0 | c3 | | d4 | 0 | f4 | 0 | | 0 |
| T5 | a4 | b4 | 0 | | 0 | 0 | f5 | 0 | | 0 |
| Tn − 1 | an − 1 | 0 | 0 | | 0 | 0 | 0 | gn − 1 | | 0 |
| Tn | 0 | 0 | 0 | | 0 | 0 | 0 | 0 | | 0 |

The matrix example above shows a WACLS signal S1 with non-zero entries from time intervals T2 to Tn−1. This is the independent timing signal for all other detector channels. The other light scatter detectors S2 to Sn are not necessarily WACLS detectors, and therefore have zero values during the time T2 to Tn−1. The fluorescence feature with emission wavelength F1 is small and localized within interval T2. This represents a feature that can be used to mark the “tail” of the organism (see FIG. 1).

The fluorescence feature with emission wavelength F2 is not as small (along the axial direction) and occurs at a different location than the F1 feature. The relative location of the feature is established by reference to the timing initiated by the WACLS detector signal S1. If the velocity of the organism is known and the “tail” marker is used, then the absolute location of this feature can be determined as well. The fluorescence feature with emission wavelength F3 shows up in two small locations indicated in the WACLS timing sequence as T3 and Tn−1.

Each scanned organism can be represented by a parametric matrix of this kind. While not containing as much information as a microscope image of the organism, the data acquisition times for such matrices are of the order of five microseconds to 250 microseconds, depending on the length of the organism. This high speed is achieved because simple, fast photomultipliers collect the scattered light and no image is formed. In cytometers images are usually stored by CCD cameras, which are inherently less sensitive than photomultipliers, and therefore require more time to collect enough photons to form an image. Imaging times for fluorescence analysis of organisms such as C. elegans are of the order of 50 milliseconds, which is from 200 to 10,000 times slower than the time required to collect and store the parametric data described above. The sampling time and the speed of the organism determine the spatial resolution of the parametric method. For example, when the organism typically travels at about 500 cm/sec through the analysis beam, then for a five microsecond sampling time the spatial resolution is approximately 25 μm.

### BRIEF DESCRIPTION OF THE DRAWINGS

FIG. 1 shows a diagrammatic representation of optics, flow cell, command electronics, and fluid switch.

FIG. 2 shows a diagrammatic representation of the optical beams of the instrument of FIG. 1

FIGS. 3A and 3B show diagrams relating fluorescence signals (gated by one of the methods of the invention) related to hermaphroditic (FIG. 3A) and male (FIG. 3B) C. elegans as measured by the instrument of the present invention.

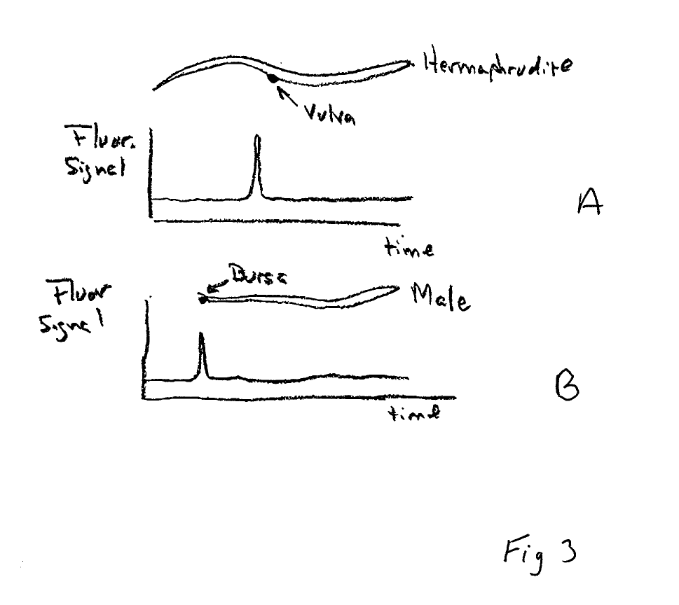

FIG. 4A shows an actual oscilloscope traces from a NACLS (lower trace) forward light scatter detector placed at a 45 degree forward light scatter angle and fraction of a degree below the to the optical axis and a fluorescence detector (upper trace) at right angles to the optic axis.

FIG. 4B shows an actual oscilloscope traces from a NACLS (lower trace) forward light scatter detector placed at 45 degrees from the to the optical axis and a fluorescence detector (upper trace) at right angles to the optic axis.

FIG. 5 shows actual oscilloscope traces from an extinction detector (lower trace)placed on the optical axis and a fluorescence detector at right angles to the optical axis (upper trace).

FIG. 6A shows actual oscilloscope traces from a WACLS forward light scatter detector (lower trace) and a fluorescence detector at right angles to the optical axis (upper trace); the C. elegans samples scanned showed several discreet points of fluorescence.

FIG. 6B shows actual oscilloscope traces from a WACLS forward light scatter detector (lower trace) and a fluorescence detector at right angles to the optical axis (upper trace); the C. elegans specimens scanned showed a small additional fluorescence at one end.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide optical gating devices and methods for use with an optical analyzer/sorter designed for elongated multicellular organisms.

The Flow Scanning Experimental System

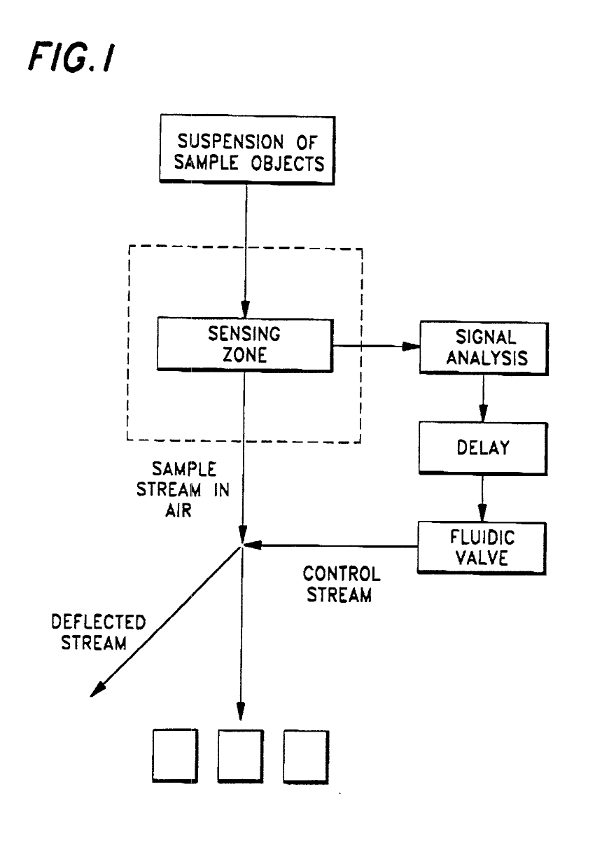

An instrument such as that shown schematically in FIG. 1 was constructed with an interchangeable pair of lasers (argon ion and helium-neon) as the light source. Detection was carried out variously with silicon photodetectors and photomultipliers. The flow cell was rectangular with a square cross-section capillary measuring 250 μm on a side for use with C. elegans. The flow cell capillary was 1000 μm on a side to accommodate first through third instar, D. melanogaster larvae. Sheath flow is used to orient these elongate organisms as they emerge from the sample nozzle and enter the flow cell capillary.

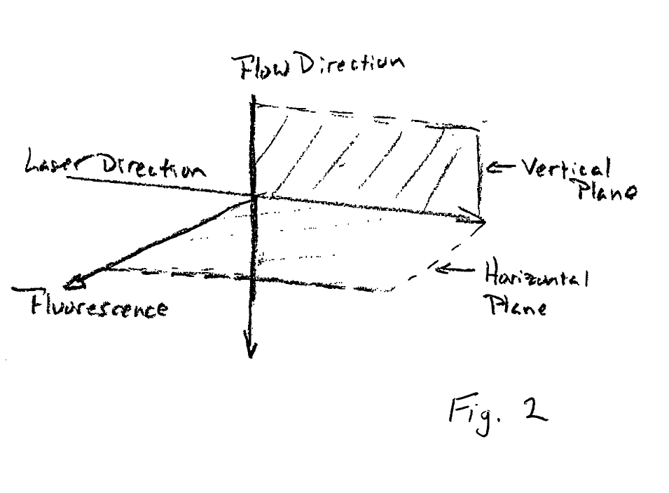

This capillary flow cell is located at the line focus of the laser beam. FIG. 2 diagrammatically shows the geometric relationship of the flow and the various optical beams. The fluorescent light is collected by simple aspheric lenses or microscope objectives and passed through emission filters to photomultipliers. By virtue of the focused laser beam and the collection lenses, the flowing organism is optically scanned as it passes through the focus.

Simultaneous NACLS and Fluorescence From C. elegans

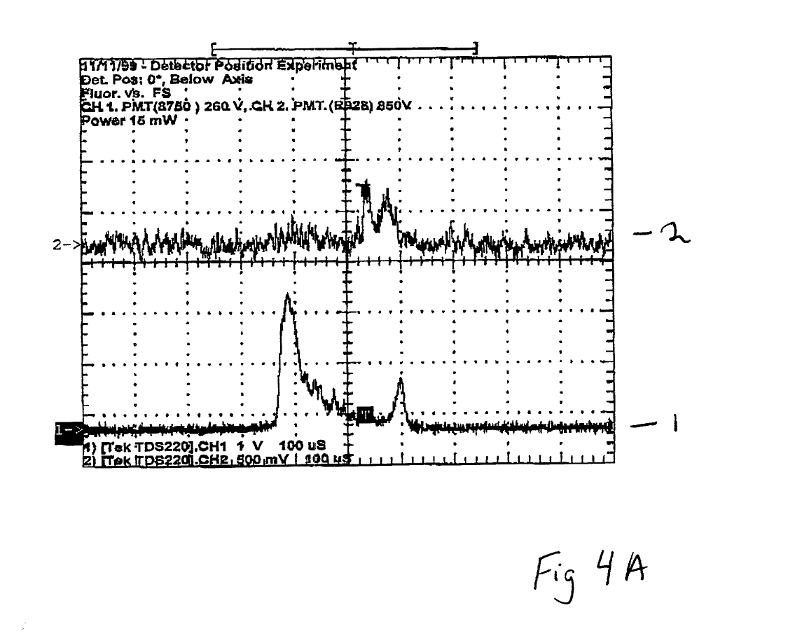

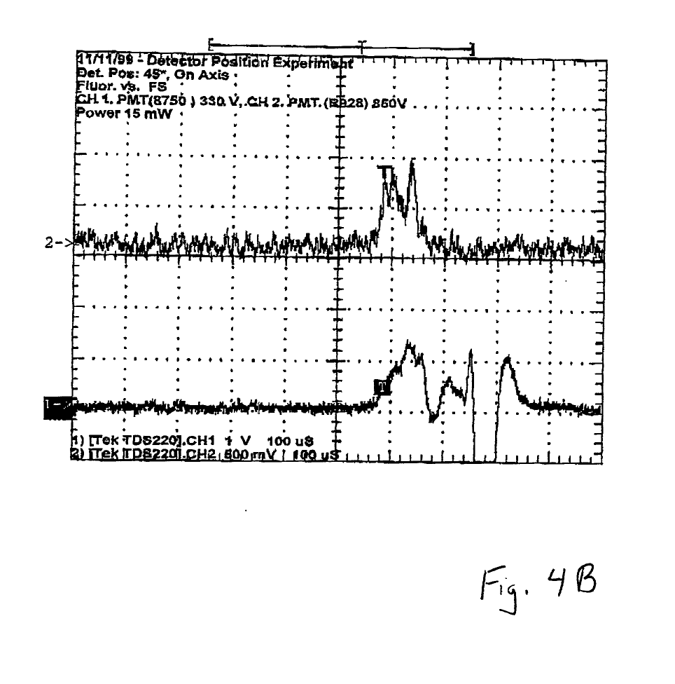

A light scatter sensor was placed at various angular positions with respect to the optical axis in the forward scatter direction. The collection cone angle was approximately six degrees (NACLS). A photomultiplier with a 20×-collection lens and a barrier filter optimized for fluorescence from GFP was used on the fluorescence detector. The C. elegans that were used for this illustration expressed GFP at two locations in the “head” and nowhere else. The oscilloscope traces for light scatter and fluorescence are shown in FIGS. 4A and 4B.

The traces show the passage of the organism through the line focus laser beam. The lower trace 1 is the light scatter signal and the top trace 2 is the fluorescence signal. The x-axis is time. FIG. 4A is typical of a class of light scatter trace observed with a NACLS detector. The detector was placed at a 45 degree forward light scatter angle directly below the laser beam axis (below the horizontal plane in FIG. 2) as it emerged from the flow cell. No scattered light from the flow cell structures themselves was incident on the detector. The NACLS signal appears to rise at the proper time. The onset of the NACLS trace and the weak autofluorescence trace from the anterior structures of the nematode coincide. The NACLS signal appears to return to baseline after the fluorescent head passes. Unfortunately, the trace returns to baseline approximately during the middle of the passage of the nematode as well. This would give the false impression that two organisms had passed rather than one. This NACLS signal demonstrates the need for a new, unambiguous trigger and timing signal.

FIG. 4B illustrates another problem associated with improper placement of a light scatter detector for triggering. In this example, the same detector was placed in the horizontal plane of FIG. 2, but at an angle of 45 degrees to the forward direction. In this case, stray, scattered light from the capillary was incident on the detector. A baseline restoration circuit was used to zero out this light level. The NACLS trace shows a false return to baseline that is caused by the acceptance cone angle being too small, and in addition a place where the signal becomes negative. The negative going region is caused when stray light from the flow cell is blocked by the nematode to an extent that there is more light blockage than there is light scatter. This signal could not be used as a trigger or timing signal for two reasons. The first is that the detector acceptance cone was too small and the second was that stray light on the detector became blocked by the passage of the nematode.

Problems Associated with Optical Extinction Signals as Trigger and Timing Signals

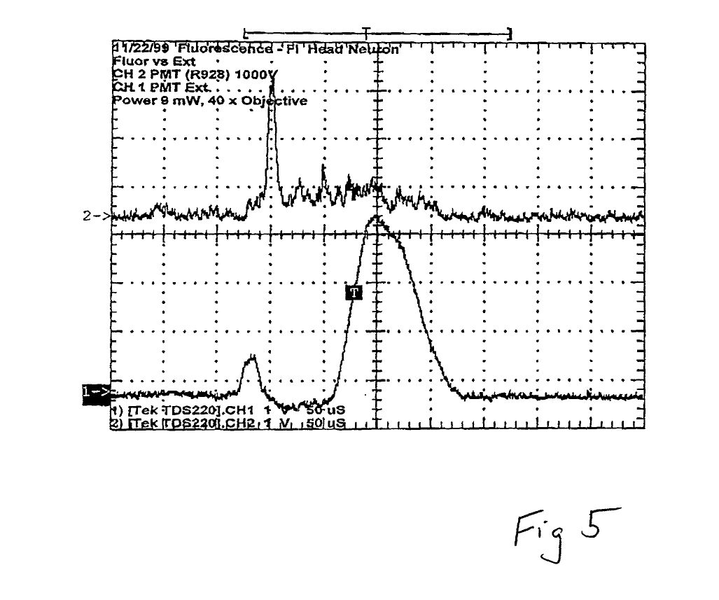

FIG. 5 illustrates another problem associated with improper placement of a light scatter detector for triggering. In this case a sensor was place directly on axis and in the laser beam. The object was to measure light blockage (extinction)by the organisms. Light extinction is a possible alternative to the preferred WACLS trigger of the present invention. The test C. elegans had a single weak region of fluorescence at a neuronal location in the head located slightly posterior to the tip of the “nose”. A 40×objective was used to collect more light since this organism was very weakly fluorescent. The extinction sensor collected light over a two degree cone. In this case extinction trace returns to baseline during the passage of the nematode, and even becomes slightly negative. Therefore, this signal could not be used as a trigger or timing signal.

Simultaneous WACLS and Fluorescence From C. elegans

A photodetector was placed on the optic axis with a collection cone angle of approximately 30 degrees (WACLS). A mask was placed over the center front of the detector to block any directly transmitted light or stray scattered light from the flow cell capillary. This way, the detector collected light scatter from the organisms over a several times wider cone angle than in the previous examples. The photomultiplier with a 40×collection lens and a barrier filter for green fluorescence protein was used to detect fluorescence since the fluorescence signal was very weak.

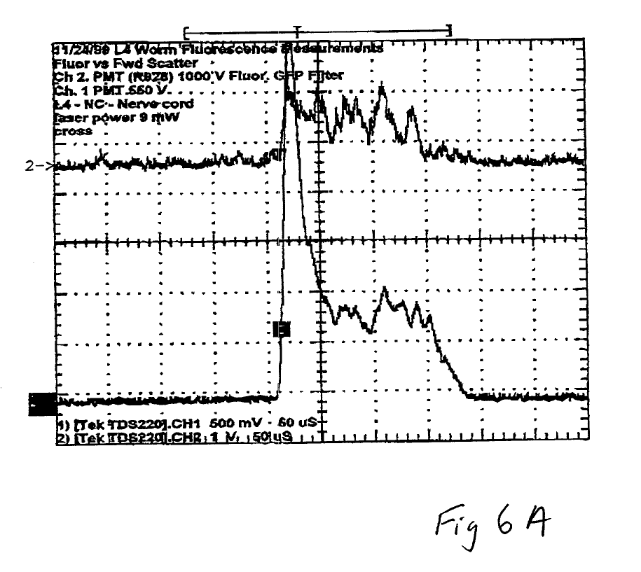

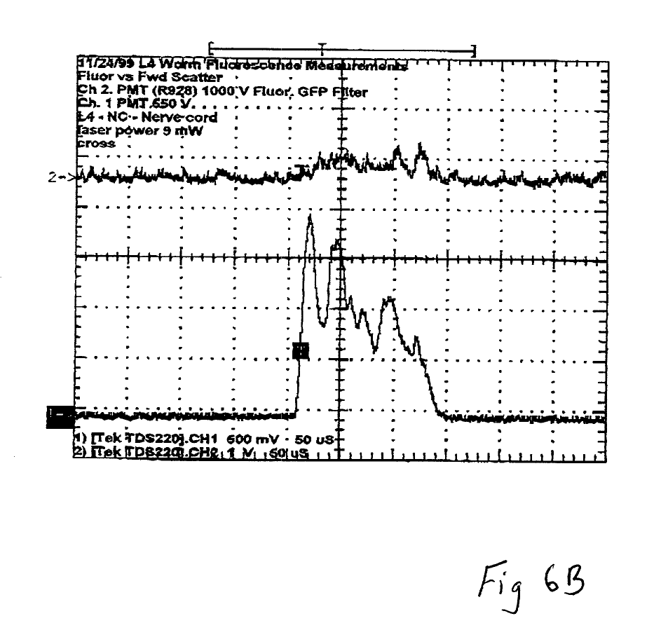

FIG. 6A shows a WACLS signal on the lower trace and the associated fluorescence signal on the upper trace. Note that the WACLS signal begins and ends at the proper time and does not return to baseline during the passage of the nematode. This was a consistent and systematic observation so long as the acceptance angle was sufficiently wide and light from the illuminating beam or the scatter detector did not collect stray light. The particular C. elegans used for this example expressed fluorescence along its entire length with 5 to 6 points along the axis where the expression was locally stronger. Some evidence for these local peaks can be seen in the fluorescence trace. The WACLS signal begins and ends at the proper time and does not return to baseline during the passage of the nematode through the laser beam. There were no exceptions to this observation when over 500 nematodes were analyzed. In the examples of useless trigger signals described above almost half of the signals returned to baseline improperly.

FIG. 6B also shows the traces for a C. elegans with very weak fluorescent protein expression. There is a low level of autofluorescence throughout the length of the organism and two local regions of weak expression near the tail. The WACLS signal begins and ends at the proper time and does not return to baseline during the passage of the nematode through the laser beam. The fluorescence signal is far too noisy to serve as a self trigger and timing signal, however the onset and end of the WACLS signal is strong and unambiguous, and could be used to time and guide an analysis of the fluorescence trace to the location of the two weak peaks.

In addition to the equivalents of the claimed elements, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope and spirit of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. An instrument for analyzing and selectively dispensing elongate multicellular organisms comprising:
a source containing multicellular organisms in a fluid suspension;
means for causing the fluid suspension to move in a direction of flow;
means for aligning the elongate multicellular organisms relative to the direction of flow;
a light source for producing an optical beam through which the elongate multicellular organisms pass after becoming aligned;
a first optical detector for detecting light over a solid angle of at least 20 degrees for receiving light scattered by the elongate multicellular organisms for detecting passage of said organisms through said optical beam; and
a fluid switch downstream of a point where said organisms pass through said optical beam, said switch responsive to the first optical detector to allow detected objects to pass to a sample container.

2. The instrument of claim 1 further comprising additional optical detectors for detecting sequential optical characteristics arrayed along a length of the multicellular organism wherein outputs of said detectors are gated by an output of the first optical detector to produce gated outputs.

3. The instrument of claim 2 further comprising a data representation of the sequential optical characteristics comprised of the outputs of the additional optical detectors.

4. The instrument of claim 3 further comprising a controller connected to the fluid switch and operative to cause said switch to select multicellular organisms showing data representations meeting predetermined criteria.

5. A method of selectively dispensing elongate multicellular organisms comprising the steps of:
centering and orienting the sample objects in a flowing fluid stream;
passing the fluid stream through a sensing zone;
optically detecting the presence of a multicellular organism passing through the sensing zone by means of a light scatter sensor that has an acceptance angle of at least 20 degrees;
creating a data representation of sequential optical characteristics of the multicellular organism comprising output signals from additional optical sensors;
diverting at least some portion of the fluid stream with a switched fluid stream based on the data representation so as to collect ones of the multicellular organisms remaining in portions of the sample stream that were not diverted.

6. The method of claim 5 further comprising the step of exposing the multicellular organisms collected in the step of diverting to a test chemical or test environment.

7. The method of claim 5 further comprising the step of exposing the multicellular organisms to a test chemical or a test environment prior to the detecting step to determine whether the data representation is altered by the test chemical or the test environment.

8. A data structure representative of an oriented elongate multicellular organism containing indicia of sequential optical characteristics disposed along a length of said organism, said data structure comprised of stored sequential outputs derived from optical sensors arranged to receive optical energy emanating from the elongate multicellular organism as said organism passes through an optical beam wherein a signal from a light scatter sensor that has an acceptance angle of at least 20 degrees is used to create or utilize the data structure.
